(19) United States
(12) Patent Application Publication
(10) Pub. No.: US 2021/0295744 A1
(43) Pub. Date: Sep. 23, 2021

(54) SHRINK SLEEVE LABEL

(71) Applicant: Multi-Color Corporation, Batavia, OH (US)

(72) Inventor: Daniel R. Ray, Algoma, WI (US)

(21) Appl. No.: 17/202,492

(22) Filed: Mar. 16, 2021

Related U.S. Application Data
(60) Provisional application No. 62/993,313, filed on Mar. 23, 2020.
(60) Provisional application No. 62/990,735, filed on Mar. 17, 2020.

(51) Int. Cl. G09F 3/00; B65D 23/08; G09F 3/10

(52) U.S. Cl. CPC G09F 3/0289; G09F 2003/0251; G09F 3/10; B65D 23/0878

(57) ABSTRACT

A shrink sleeve having a portion thereof that can be used for extended text or game information, or coupon, or other label information.

### CROSS-REFERENCE TO RELATED APPLICATIONS

This application claims the benefit of the filing date of U.S. Patent Application Ser. No. 62/990,735, filed on Mar. 17, 2020, and U.S. Patent Application Ser. No. 62/993,313, filed on Mar. 23, 2020, the disclosures of which are incorporated by reference herein in their entireties.

### FIELD OF THE INVENTION

The present invention generally relates to labels including shrink films (such as shrink sleeve labels), and more specifically relates to shrink sleeve labels including an extended portion for extended content or other purposes.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Shrink films, such as shrink sleeves and shrink wraps, are used in labeling, often as an alternative to pressure-sensitive labels, heat-transfer labels, in-mold labels, and other types of labels. Shrink labeling involves sizing a shrink film, which may be a tubular shrink sleeve, to a particular article. Then one shrinks the film to snugly wrap the article within the shrink sleeve. The shrinking process is generally accomplished by the application of heat or steam to the shrink sleeve. The material used for shrink films, such as a shrink sleeve, may depend on the shape and weight of the article and its contents. For example, shrink sleeves may include materials such as polyethylene terephthalate, polyethylene terephthalate glycol, polyvinyl chloride, or oriented polystyrene. The film has an inherent tension that is released by heating the film from the outside in a shrink oven. As the film is heated, it shrinks snugly around the article. This shrinkage applies a very slight pressure to the article, which aids in holding the shrink film to the article. In alternate embodiments, an adhesive may be applied to the inner surface of the shrink sleeve.

Graphics—such as pictures, logos, text, and other indicia—which provide label information, may be printed on the shrink films. Typically, such label information/graphics is/are reverse-printed on the shrink films and the shrink films then seamed, thereby forming a shrink sleeve, although the label information/graphics may alternatively (or additionally) be printed on the surface of the shrink film that will be opposite any article to which the label is ultimately applied. In general, shrink films are reverse-printed using flexographic and rotogravure printing technology. A master roll of shrink film is prepared with a number of label copies across its surface. The particular number of labels depends upon the size of the label copy and the width of the master roll. The printed rolls may then be slit-cut, thereby forming individual rolls. The slit rolls are then folded and overlapped, and seamed at the edge, forming a shrink sleeve that is wound on a core. The finished roll fed or individually cut shrink sleeve labels are packaged and delivered to a particular location where each of the shrink sleeves will be applied to an article.

The label information present on labels (such as shrink sleeve labels) is typically present in a manner that is readily visible when the label is associated with an article. However, it may be the case, or desired, that some label information associated with the label be done so in a manner that is not readily visible when the label is associated with an article. For example, extended text may be associated with labels (such as by being affixed to the existing label). Labels including such extended text portions may be referred to as extended content labels. Extended content labels can be used to increase label space to provide information about the article or contents of the article, or to provide information in a manner that does not detract from the primary label graphics visible to a consumer. Information included in the extended text portion of an extended content label may be information concerning directions for use of a product, or information required by a government agency, for example.

Other types of label information that may not be initially readily visible when the label is associated with an article include coupons and/or game pieces. Labels that include removable sections having a coupon or a game piece printed thereon are known. The removable section allows the coupon or game portion of the label to be removed and redeemed. In order to prevent disruption of the aesthetics of the overall label, or to prevent one from being able to see the game information prior to removal, this information may be printed on the surface of the removable section that faces the article.

While different types of labels (e.g., pressure sensitive labels) may include extended portions for extended content, shrink sleeve labels have not typically included such extended portions. And when extended content, or coupons, or game pieces have been associated with shrink sleeve labels, this is often accomplished by providing a separate second label (such as a pressure sensitive label) including that additional information—and then affixing that second label to the shrink sleeve label. The use of such a second label for extended content, coupons, game pieces, or other information suffers drawbacks of extra expense and extra steps of providing the second label, along with problems of the second label perhaps separating from the shrink sleeve label, as it is not integral therewith.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As described above, there presently are drawbacks to providing extended content portions for shrink sleeve labels. And so, in one aspect, the present invention overcomes these drawbacks and provides a shrink sleeve having a portion thereof integral therewith that can be used for extended content [i.e., extended text, or game piece(s), or coupon(s), or other label information].

To accomplish this, one embodiment of the present invention includes a shrink film that is of sufficient dimensions such that when it is folded over on itself and seamed (such as by being glued or otherwise adhered), an extended portion (i.e., an overhang) extends beyond the seam, such that the shrink film includes a first portion that can form a tubular portion of a shrink sleeve, and a second portion that can be used for extended content (i.e., the first portion is the sleeve portion, and the second portion is the extended content portion). In other words, a first seam formed between the sleeve portion and a first end of the extended content portion delineates the extended content portion from the sleeve portion. The sleeve portion is integral with the extended content portion so that the extended content portion cannot be readily removed from the sleeve portion. A distal end of the extended content portion is then also seamed to the sleeve portion to form a second seam.

In one aspect of the present invention, the label may be designed such that the extended content portion that is integral with the sleeve portion is removable from the remainder of the label (i.e., removable from the sleeve portion). This may be accomplished in certain embodiments via the use of one or more weakened areas of the extended content portion. Such a weakened area or areas may be provided by one or more perforations, for example. For example, a weakened edge (such as by perforation, for example) may be used to allow the extended content portion to be removed. This embodiment may be useful in the context of coupons or game pieces provided on the extended content portion.

And so, in one embodiment, a first perforation may be provided at, or proximal to, the end of the extended content portion proximal to the second seam. This allows one to separate the extended content portion from the sleeve portion at or near the distal end of the extended content portion. The extended content portion can then be peeled back and away from the sleeve portion to reveal any label graphics on the surface of the extended content portion that originally faced the sleeve portion (such as to provide a coupon or game piece, for example). One would be able to peel the extended content portion back until reaching the first seam. To fully separate the extended content portion from the sleeve portion, a second perforation may be provided proximal to the first seam between the extended content portion and sleeve portion. Separation along this second perforation allows complete removal of at least a portion (e.g., a substantial portion or all) of the extended content portion.

In certain embodiments, the first perforation at or proximal to the distal end of the extended content portion may be a zipper perforation. As is known to those of ordinary skill in the art, a zipper perforation generally may include two substantially parallel perforations (a first zipper perforation component and a second zipper perforation component) set relatively close to one another, thereby providing a strip of material (such as a strip of the shrink film material of the extended content portion) located therebetween. The strip of material may be separated and removed from the extended content portion along the perforations of the zipper perforation (generally by grasping and pulling one end of the strip of material). A cut area and/or a tab portion may be provided at one end of the strip of material to facilitate removal of the strip of material along the perforations of the zipper perforation. Alternatively, tear strip tape could be laminated along the first perforation to allow a used to remove the tear strip tape, thus opening the perforation. Once the strip of material is removed along the zipper perforation, the extended content portion may be peeled back and removed as described above.

Alternatively, once the extended content portion proximal to the distal edge is separated along the first perforation, and the extended content portion peeled back to the seam, the extended content portion may be removed by cutting the extended content portion from the sleeve portion (such as with scissors).

In yet another embodiment, the extended content portion may be designed such that it is not fully removed from the sleeve portion. In such an embodiment, a releasable and resealable material (such as a releasable and resealable adhesive) may be applied to an edge of the extended content portion distal from the seam. This releasable and resealable material permits the extended content portion to be released from and subsequently resealed to the sleeve portion a plurality of times. This allows any label information (such as printed material) on the extended content portion to be read by a user as frequently as desired. It also allows any label information (such as printed material) on the sleeve portion underlying the extended content portion to be read by a user as frequently as desired.

Via use of the shrink sleeve label (including a sleeve portion and an integral extended content portion) described above, another aspect of the present invention provides a decorated article, such as a container used to package an item or items. The decorated article includes a shrink sleeve and an article. The article has a top end, a bottom end, and a side surface. The article may further include a centerpoint of the top end and a centerpoint of the bottom end with a longitudinal axis passing therethrough. The extended content shrink sleeve label (such as described above) is shrunk around at least the side surface of the article, and includes at least one visible decoration on a surface of the shrink sleeve, and includes an extended content portion integral with a sleeve portion.

Another aspect of the present invention provides a method of applying an extended content shrink sleeve label to an article. The method includes providing an extended content shrink sleeve label having an axis of symmetry and at least one decoration (a “decoration” being graphics such as would include label information) visible on an outer surface of the shrink sleeve. One also provides an article, the article having a top end, a bottom end, a side surface, and a longitudinal axis passing through a centerpoint of the top end and a centerpoint of the bottom end. The article is oriented such that the longitudinal axis is substantially parallel to the axis of symmetry. The extended content shrink sleeve label is positioned over and around the article such that at least a portion of the article is disposed within and substantially surrounded by the extended content shrink sleeve label. And the extended content shrink sleeve label is shrunk such that the extended content shrink sleeve label constricts around at least a portion of the side surface of the article, thereby positioning the extended content shrink sleeve label such that at least some label information is visible on an outer surface of the extended content shrink sleeve label (with further information being included on a surface of the extended content portion that is not visible).

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a plan view of a blank of a shrink film for forming an extended content shrink sleeve label in accordance with principles of the present invention prior to seaming.

FIG. 2A is a perspective view of a shrink film for an extended content shrink sleeve label in alignment with an article to be labeled.

FIG. 2B is a perspective view of the extended content shrink sleeve label applied to an article.

FIG. 3A is a top view of the extended content shrink sleeve label of FIG. 2A

FIG. 3B is a top view of the extended content shrink sleeve label of FIG. 3B showing the label as seamed and as having the distal edge of the extended content portion being adhered to the shrink sleeve portion of the label.

FIG. 4 is a perspective view of an embodiment of an extended content shrink sleeve label including a zipper perforation, and showing the process of removal of a strip of material associated with the zipper perforation.

FIG. 5 is a perspective view of an embodiment of the extended content shrink sleeve label of FIG. 4 showing the extended content portion as now removed from the remainder of the label.

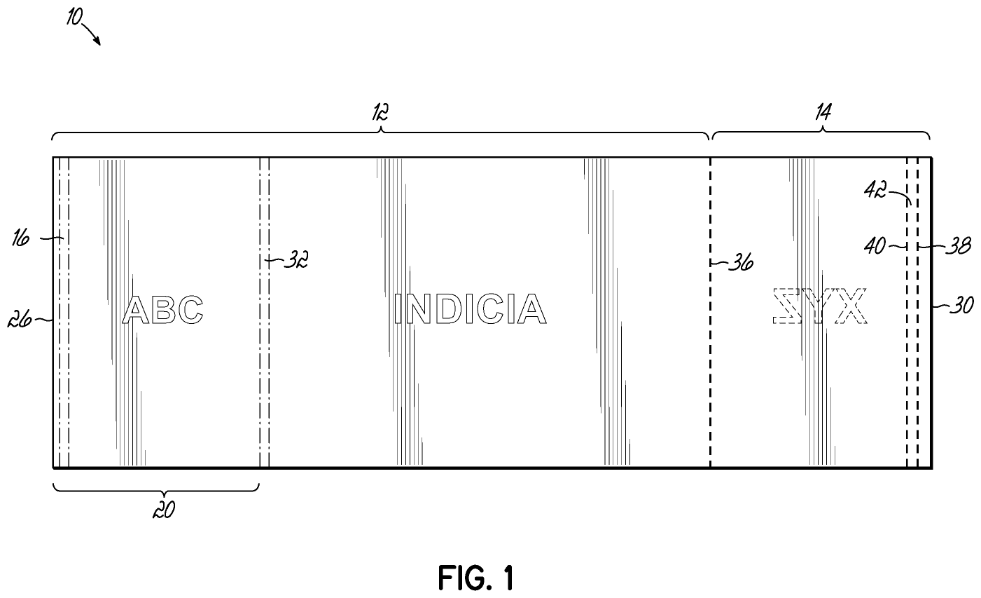

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, there presently are drawbacks to providing extended content portions for shrink sleeve labels. And so, in one aspect, the present invention overcomes these drawbacks and provides a shrink sleeve having a portion thereof integral therewith that can be used for extended content [i.e., extended text, or game piece(s), or coupon(s), or other label information].

To accomplish this, and referring now to the Figures, one embodiment of the present invention includes a shrink film 10 that is of sufficient dimensions such that when it is folded over on itself and seamed (such as by being glued or otherwise adhered), an extended portion (i.e., an overhang) extends beyond the seam, such that the shrink film includes a first portion 12 that can form a tubular portion of a shrink sleeve, and a second portion 14 that can be used for extended content (i.e., the first portion is the sleeve portion, and the second portion is the extended content portion; thus, herein the terms “first portion” and “sleeve portion” are interchangeable, and the terms “second portion” and “extended content portion” are interchangeable).

In other words, a first seam 16 formed between the first portion (sleeve portion) 12 and a first end 18 of the second portion (extended content portion) 14 delineates the extended content portion 14 from the sleeve portion 12. More specifically, when forming an extended content label, the shrink film 10 may be folded over or wrapped such that a first end 26 of the shrink film 10 (or an area proximal to the first end 26) is then adhered to an overlapping portion of the shrink film (i.e., the extended content portion 14) to form the first seam 16. After formation of first seam 16, the sleeve portion 12 and the extended content portion 14 are formed, resulting in an extended content shrink sleeve label 28. The sleeve portion 12 is integral with the extended content portion 14 so that the extended content portion 14 cannot be initially readily removed from the sleeve portion 12. Further, the extended content portion 14 overlies an underlying section 20 of the shrink film 10 once the label 28 is formed.

An end 30 (distal end) of the second portion (extended content portion) 14 (or an area of shrink film 10 proximal to end 30) is then also seamed to the sleeve portion 12, thereby forming a second seam 32. This may be accomplished by use of a permanent seaming solvent, for example. Alternatively, the permanent seaming solvent (or other material for adhering extended content portion 14 to sleeve portion 12) may be applied to a portion of the sleeve portion underlying the extended content portion (and at, or proximal to, the edge of the extended content portion distal from the first seam 16).

In this aspect of the present invention, the label may be designed such that the extended content portion 14 that is integral with the sleeve portion 12 is removable from the remainder of the label (i.e., removable from the sleeve portion 12). This may be accomplished in certain embodiments via the use of one or more weakened areas of the extended content portion 14. Such a weakened area or areas may be provided by one or more perforations, for example. For example, a weakened edge (such as by perforation, for example) may be used to allow the extended content portion 14 to be removed. This embodiment may be useful in the context of coupons or game pieces provided on the extended content portion 14.

And so, in one embodiment, a first perforation 34 may be provided at, or proximal to, the end 30 of the extended content portion 14 proximal to the second seam 32. This allows one to separate the extended content portion 14 from the sleeve portion 12 at or near the distal end 30 of the extended content portion 14. The extended content portion 14 can then be peeled back and away from the sleeve portion 12 to reveal any label graphics on the surface of the extended content portion 14 that originally faced the sleeve portion 12 (such as to provide a coupon or game piece, for example). One would be able to peel the extended content portion 14 back until reaching the first seam 16. To fully separate the extended content portion 14 from the sleeve portion 12, a second perforation 36 may be provided proximal to the first seam 16 between the extended content portion 14 and sleeve portion 12. Separation along this second perforation 36 allows complete removal of at least a portion (e.g., a substantial portion or all) of the extended content portion 14.

Alternatively, once the extended content portion 14 proximal to the distal end 30 is separated along the first perforation 34, and the extended content portion 14 peeled back to the first seam 16, the extended content portion 14 may be removed by cutting the extended content portion 14 from the sleeve portion 12 (such as with scissors). (This embodiment is not shown in the figures.)

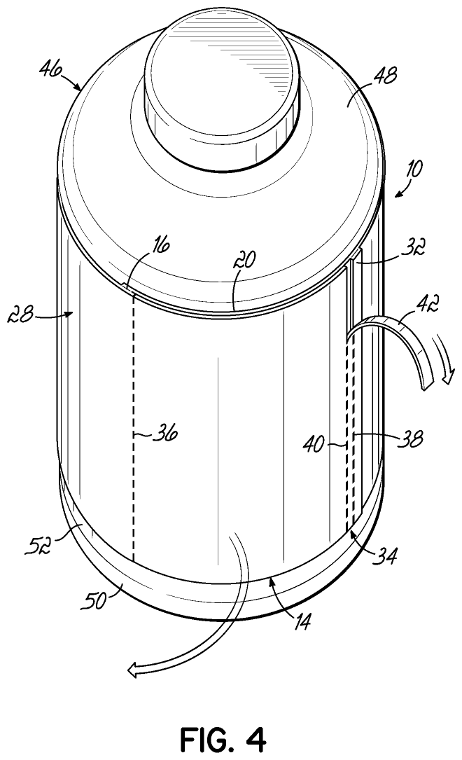

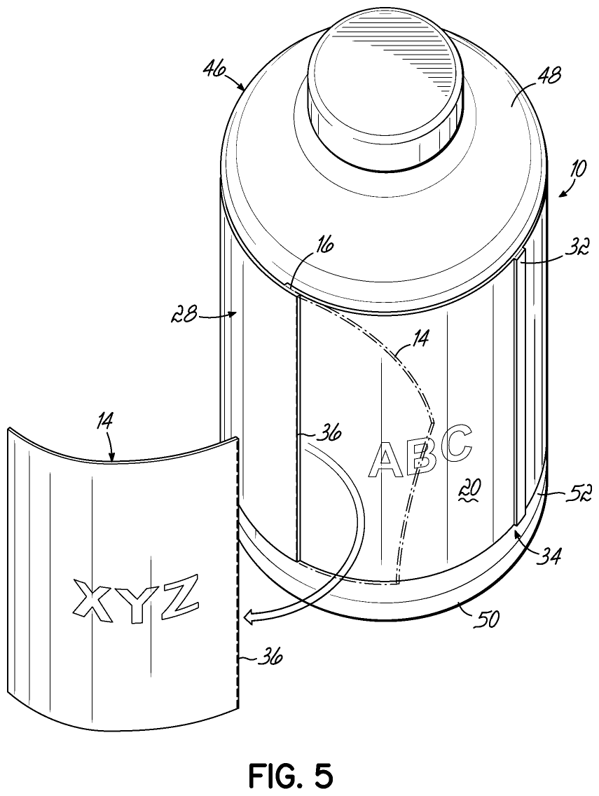

In another embodiment, the first perforation 34 at or proximal to the distal end 30 of the extended content portion 14 may be a zipper perforation. As is known to those of ordinary skill in the art, a zipper perforation generally may include two substantially parallel perforations (described herein as a first zipper perforation component 38 and a second zipper perforation component 40) set relatively close to one another, thereby providing a strip 42 of material (such as a strip of the shrink film material of the extended content portion 14) located therebetween. The strip 42 of material may be separated and removed from the extended content portion 14 along the perforations of the zipper perforation (generally by grasping and pulling one end of the strip 42 of material)—see FIG. 4. A cut area and/or a tab portion (not shown) may be provided (in certain embodiments) at one end of the strip 42 of material to facilitate removal of the strip 42 of material along the first and second zipper perforation components 38, 40 of the zipper perforation. Once the strip 42 of material is removed along the zipper perforation, the extended content portion 14 may be peeled back and removed as described above.

Those skilled in the art will recognize that the descriptions and location of perforations described above can be “reversed.” In other words, the first perforation could be located proximal to the sleeve portion 12, with the extended content portion 14 then being peeled back toward the distal end 30 of the extended content portion 14 and removed at the distal end 30 with a second perforation or by being cut off. And the first perforation proximal the sleeve may be a zipper perforation. In still other embodiments, multiple zipper perforations may be provided. And, in embodiments where only a first perforation (which could be a zipper perforation) is provided at or proximal to the first seam 16, the extended content portion 14 could be removed by being cut off (such as with scissors) at or proximal to the distal end 30 of the extended content portion 14.

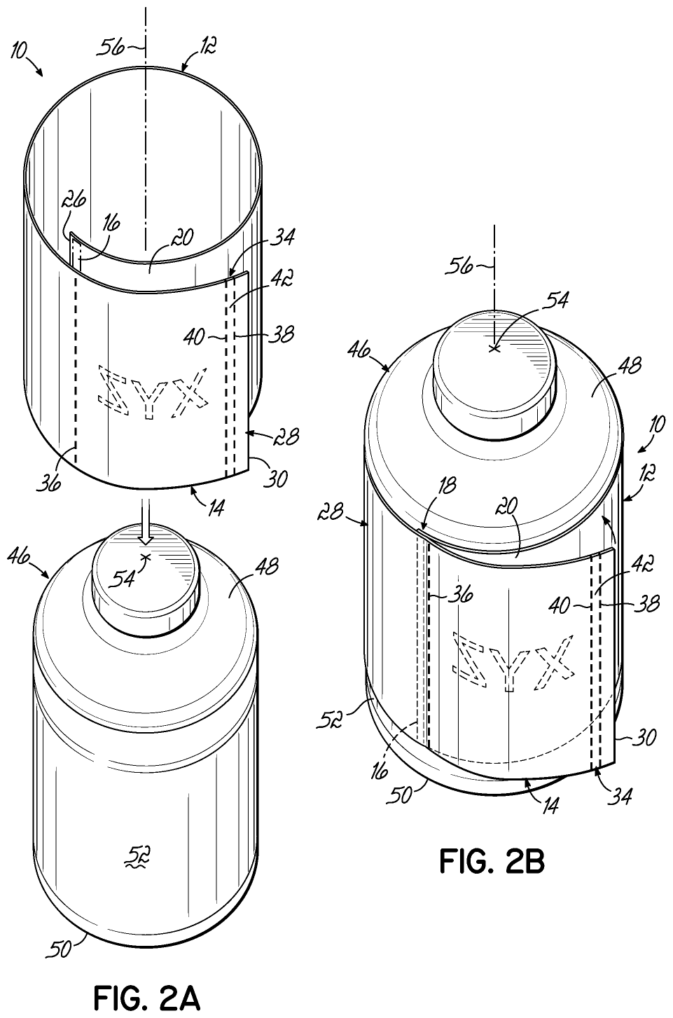

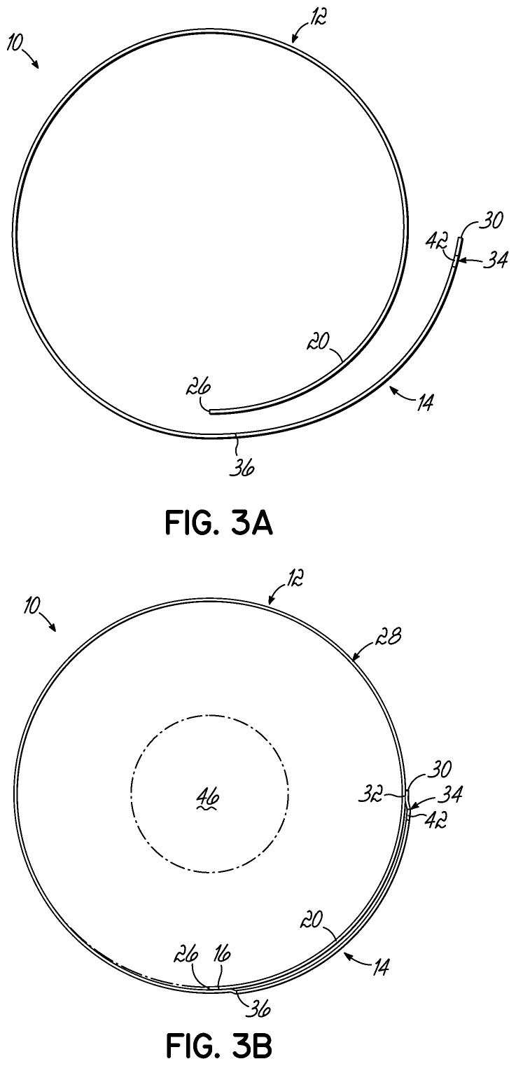

Referring to FIGS. 2A and 2B, the extended content shrink sleeve label 28 is shown with the extended content portion 14 in an open position. Label information/graphics may be included on both sides of the extended content portion 14, as well as on the sleeve portion 12 underlying the extended content portion 14. Since the extended content portion 14 is an integral portion of extended content shrink sleeve label 28, a greater degree of label information can now be included on the extended content shrink sleeve label 28 as compared to prior shrink sleeve labels.

Via use of the extended content shrink sleeve label 28 (including a sleeve portion 12 and an integral extended content portion 14) described above, another aspect of the present invention provides a decorated article, such as a container used to package an item or items. Referring particularly to FIGS. 2A and 2B, a decorated article includes an extended content shrink sleeve label 28 and an article 46. The article has a top end 48, a bottom end 50, and a side surface 52. The article may further include a centerpoint 54 of the top end 48 and a centerpoint of the bottom end 50 with a longitudinal axis 56 passing therethrough. The extended content shrink sleeve label 28 (such as described above) is shrunk around at least the side surface 52 of the article 46, and includes an extended content portion 14 integral with a sleeve portion 12.

The extended content shrink sleeve label 28 is shrunk around at least the side surface 52 of the article 46, and includes at least one visible decoration on a surface of the extended content shrink sleeve label 28. Such a decoration may be provided by various inks well known to those skilled in the art. These may be reverse-printed on or proximal to the inner surface of the shrink films (i.e., the surfaces that will be applied toward the surface of the article 46). Alternatively, the inks may be applied on or proximal to the outer surface of the shrink films. “Applied on,” as used here, means there is direct contact between the inks and the surface of the shrink film. “Applied proximal to,” as used here, means that although the inks are applied to the same side as a surface of the shrink film 10, it is not necessary that there be any direct contact between the inks and the surface (although there may be). For example, another layer, or layers, may be disposed between the inks and the surface that the inks or inks are “applied proximal to.”

Another aspect of the present invention provides a method for providing an extended content shrink sleeve label 28 over an article 46 such that, in use, the extended content shrink sleeve label 28 will not slip or tear away from the article 46 with which it is associated. This method includes the steps of first providing an extended content shrink sleeve label 28 generally as described above, which has an axis of symmetry 46.

The method of the present invention also includes providing an article 46 having a top end 48, a bottom end 50, a side surface 52, and a longitudinal axis 56 passing through a centerpoint 54 of the top end 48 and a centerpoint of the bottom end 50. This article 46 is then oriented such that the longitudinal axis 56 of the article 48 is substantially parallel to and/or aligned with the axis of symmetry 46 of the extended content shrink sleeve label 28.

Next, the extended content shrink sleeve label 28 is positioned over and around the article 46 such that at least a portion of the side surface 52 of the article 46 is disposed within and substantially surrounded by the extended content shrink sleeve label 28. Finally, the extended content shrink sleeve label 28 is shrunken such that the inner surface of the extended content shrink sleeve label 28 constricts around at least a portion of the side surface 52 of the article 46.

Following shrinking, the article 46 and extended content shrink sleeve label 28 may then be cooled by subjecting the extended content shrink sleeve label 28 to ambient temperatures to allow for a gradual cooling process. Alternatively, the extended content shrink sleeve label 28 may undergo other cooling steps, such as subjecting the extended content shrink sleeve label 28 to cool air or liquid.

In yet another embodiment (not shown in the figures), the extended content portion 14 may be designed such that it is not fully removed from the sleeve portion 12. In such an embodiment, a releasable and resealable material (such as a releasable and resealable adhesive) is applied to an edge of the extended content portion 14 distal from the first seam 16. Alternatively, the releasable and resealable material can be applied to a portion of the sleeve portion 12 underlying the extended content portion 14 (and proximal to the edge of the extended content portion 14 distal from the first seam 16). As described above, when forming the extended content shrink sleeve label, a first section of the shrink film 10 is turned over at a fold over a second section and adhered to form the first seam 16. The releasable and resealable material is applied at the edge of a third section which now forms the extended content portion 14, so that extended content portion 14 can be opened and closed against the sleeve portion 12 to access additional label information. This releasable and resealable material permits the extended content portion 14 to be released from and subsequently resealed to the sleeve portion 12 a plurality of times. This allows any label information (such as printed material) on the extended content portion 14 to be read by a user as frequently as desired. It also allows any label information (such as printed material) on the sleeve portion 12 underlying the extended content portion 14 to be read by a user as frequently as desired. In such an embodiment, a perforation (which may be a zipper perforation) may be provided proximal to the releasable and resealable material, such that the perforation is first separated, with the extended content portion 14 then able to be released from, and resealed to, the sleeve portion 12. In alternate embodiments, the portion of the extended content portion 14 that includes the releasable and resealable material (and any perforation) may be located proximal the first seam 16 (rather than proximal the distal end 30 of the extended content portion 14). Thus, the releasable and resealable material is capable of being released and resealed a plurality of times. While the releasable and resealable material is described above as an adhesive (in one example), it will be recognized that any material that can release and reseal may be used, including (but not limited to) Velcro® and electrostatic material. In some situations no resealable material is needed for the label to reseal because of the inherent contraction properties of the shrink sleeve material.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A label comprising:
a shrink film having a first surface and an opposite second surface, and having first and second ends; and
a first seam formed between a portion of the first surface proximal the first end and a portion of the second surface distal from the first end;
the shrink film thus including a first portion capable of forming a tubular shrink sleeve, and a second portion extending from the seam to the second end of the shrink film.

2. The label of claim 1, further including a second seam formed between a portion of the first surface distal from the first end of the shrink film and a portion of the second surface proximal to the second end of the shrink film.

3. The label of claim 2, wherein each of the first seam and second seam, individually, includes a material between the first surface and second surface of the shrink film that adheres the first surface and second surface to one another.

4. The label of claim 3, wherein the material is a permanent seaming solvent.

5. The label of claim 2, further comprising a weakened area of the shrink film proximal to the second end of the shrink film.

6. The label of claim 5, wherein the weakened area includes a first perforation positioned substantially parallel to the second end of the shrink film and proximal to the second seam.

7. The label of claim 6, further comprising a second perforation positioned substantially parallel to the first perforation and proximal to the first seam.

8. The label of claim 5, wherein the weakened area includes a zipper perforation positioned substantially parallel to the second end of the shrink film and proximal to the second seam.

9. The label of claim 8, further comprising a second perforation positioned substantially parallel to the first perforation and proximal to the first seam.

10. The label of claim 5, wherein the weakened area includes a first perforation positioned substantially parallel to the second end of the shrink film and proximal to the first seam.

11. The label of claim 5, wherein the weakened area includes a zipper perforation positioned substantially parallel to the second end of the shrink film and proximal to the first seam.

12. The label of claim 2, wherein the second seam includes a releasable and resealable material between the first surface and second surface of the shrink film that releasably adheres the first surface and second surface to one another.

13. The label of claim 1, further comprising at least one ink disposed on an area of the second surface of the second portion of the shrink film.

14. The label of claim 1, further comprising at least one ink disposed on an area of the first surface of the first portion of the shrink film that underlies the second portion of the shrink film.

15. A decorated article comprising:
an article having a top end, a bottom end, and at least one side surface; and
a label contacting at least a portion of the at least one side surface, the label comprising:
a shrink film having a first surface and an opposite second surface, and having first and second ends; and
a first seam formed between a portion of the first surface proximal the first end and a portion of the second surface distal from the first end;
the shrink film thus including a first portion capable of forming a tubular shrink sleeve, and a second portion extending from the seam to the second end of the shrink film.
